(19) United States
(12) Patent Application Publication
(10) Pub. No.: US 2022/0402798 A1
(43) Pub. Date: Dec. 22, 2022

(54) Large-Flow Precious Metal Channel

(71) Applicants: Triumph Science & Technology Group Co., Ltd., Beijing (CN); Bengbu China Optoelectronic Technology Co., Ltd., Bengbu, Anhui (CN)

(72) Inventors: Shou Peng, Bengbu, Anhui (CN); Chong Zhang, Bengbu, Anhui (CN); Yang Jiang, Beijing (CN); Liangmao Jin, Bengbu, Anhui (CN); Zhiqiang Cao, Bengbu, Anhui (CN); Longyue Jiang, Bengbu, Anhui (CN); Min Guan, Beijing (CN); Mingliu Zhu, Bengbu, Anhui (CN); Yuguo Shen, Bengbu, Anhui (CN)

(21) Appl. No.: 17/771,634

(22) PCT Filed: Apr. 19, 2021
(86) PCT No.: PCT/CN2021/088203

§ 371 Date: Apr. 25, 2022

(30) Foreign Application Priority Data
Jun. 8, 2020 (CN) 202010510893.X

(51) Int. Cl. C03B 5/167; C03B 5/23

(52) U.S. Cl. CPC C03B 5/1675; C03B 5/23

(57) ABSTRACT

A large-flow precious metal channel is provided, which comprises a molten glass mixed-flow stirring section, at least two molten glass heating, clarifying and cooling sections are connected in parallel at one end of the molten glass mixed-flow stirring section, the other end of which is communicated with a liquid supply tank. The channel is mainly used for the clarification and homogenization of large-flow high-temperature molten glass in the production process of 8.5-generation and higher-generation TFT glass, and provides bubble-free and streak-free high-quality molten glass for subsequent float forming or overflow forming processes.

The present application claims the priority of a Chinese patent application No. 202010510893.X filed with the China National Intellectual Property Administration on Jun. 8, 2020 and entitled “Large-flow Precious Metal Channel”, which is incorporated herein by reference in its entirety.

### TECHNICAL FIELD

The present invention relates to the technical field of an electronic glass manufacturing device, and in particular to a large-flow precious metal channel mainly used in the production process of 8.5-generation and higher-generation TFT glass substrates.

### BACKGROUND

The technology of processing molten glass with precious metal channels is currently the most commonly used method for producing TFT glass. This method makes use of the advantages of the precious metal such as good temperature resistance, electric direct heating and good ductility etc. It can be directly heated to 1650° C. electrically, which can effectively discharge bubbles from TFT substrate glass at high temperatures, and enables high-quality clarification and homogenization. It is the key technical equipment for the production of TFT glass, which is easy to realize mass production. Many patents and documents in China and abroad involve this process. For example, the Chinese invention patent CN101935146B describes a method for processing molten glass in platinum channels, which realizes the clarification and homogenization of a flow rate of 5 to 20 tons/day of molten glass through five-stage processing steps of a clarifying tank, a cooling tank, a stirring tank, a homogenizing tank, and a supply tank. However, the processing capacity using this method is still very limited. In case of a large-flow molten glass of more than 20 tons/day, the high temperature mechanical strength cannot be guaranteed due to the requirement of a large platinum tube, and thus high-quality stable clarification cannot be achieved. The Chinese invention patent CN105948462A relates to a platinum channel heating device and method and a platinum channel and a glass production system. The device generates an alternating magnetic field to form an induced eddy current on the platinum channel. Heats are generated when the eddy current flows through the platinum channel to uniformly heat the platinum channel. However, this invention does not involve a specific method for processing large-flow molten glass.

### SUMMARY

To overcome the deficiencies in the prior art, the present invention provides a large-flow precious metal channel.

The present application provides the following technical solutions.

The present application provides a large-flow precious metal channel, comprising a molten glass mixed-flow stirring section, wherein, at least two molten glass heating, clarifying and cooling sections are connected in parallel at one end of the molten glass mixed-flow stirring section, the other end of which is communicated with a liquid supply tank; each of the molten glass heating, clarifying and cooling sections comprises a heating channel, which is communicated with a melting furnace at one end and is communicated with a clarifying tank and a cooling channel sequentially at the other end; the molten glass mixed-flow stirring section comprises a confluence channel, which is communicated with the cooling channel at one end; a set of spoilers are provided in the confluence channel, a stirring channel is communicated with the other end of the confluence channel and comprises at least one molten glass stirring tank, and a liquid outlet of the molten glass stirring tank is communicated with the liquid supply tank.

In some embodiments of the present invention, spoilers in the set of spoilers are distributed in a staggered manner, and a serpentine flow channel is formed inside the confluence channel by the division of the set of spoilers.

In some embodiments of the present invention, the confluence channel is communicated with at least one molten glass stirring tank sequentially at the other end, and stirring directions of two adjacent molten glass stirring tanks are different.

In some embodiments of the present invention, the heating channel has a diameter of 150 mm to 300 mm and a length of 500 mm to 1500 mm; the clarifying tank has a diameter of 250 mm to 400 mm and a length of 3000 mm to 8000 mm; the cooling channel has a diameter of 220 mm to 360 mm, and a length of 2000 mm to 6000 mm; the confluence channel has a diameter of 300 mm to 500 mm and a length of 2000 mm to 5000 mm; the molten glass stirring tank has a diameter of 350 mm to 550 mm and a stirring speed of 2 to 20 revolutions per minute; the liquid supply tank has a diameter of 300 mm to 500 mm and a length of 1000 mm to 2000 mm

In some embodiments of the present invention, a maximum temperature of the heating channel during operation is 1650° C., and a maximum temperature of the clarifying tank during operation is 1670° C., a temperature of the cooling channel during operation is 1500° C. to 1550° C., and a temperature of the liquid supply tank during operation is 1200° C. to 1400° C.

In some embodiments of the present invention, the heating channel, the clarifying tank, the cooling channel, the confluence channel, the molten glass stirring tank, the spoilers and the liquid supply tank are made of platinum rhodium alloy or platinum iridium alloy or platinum. The heating channel, the clarifying tank, the cooling channel, the confluence channel, the molten glass stirring tank, the spoilers and the liquid supply tank are each independently made of platinum rhodium alloy or platinum iridium alloy or platinum, and the materials thereof can be the same or different. Preferably, the heating channel, the clarifying tank, the cooling channel, the confluence channel, the molten glass stirring tank, the spoilers and the liquid supply tank are made of the same material of platinum rhodium alloy or platinum iridium alloy or platinum.

Beneficial effects of the embodiments of the present invention are as follows.

The large-flow precious metal channel provided by the embodiments of the present invention is simple in terms of technical equipment, and has strong operability, and excellent clarification and homogenization effect. By providing at least two parallel molten glass heating, clarifying and cooling sections, it can fully guarantee the service life and high-temperature mechanical strength of platinum in the high-temperature section while achieving high-temperature heating and clarification of large-flow molten glass. On the premise of ensuring high output, the problem of the risk of a single large-diameter molten glass channel during manufacturing being collapsed in the high-temperature section due to the pressure of the large-flow and high-liquid-level molten glass is avoided.

### BRIEF DESCRIPTION OF THE DRAWINGS

In order to describe the embodiments of the present application and the technical solution of the prior art more clearly, the drawings used in the prior art and the embodiments will be described briefly below. Obviously, the drawings described below are only some embodiments of the present application, and other drawings can be obtained by those skilled in the art according to these drawings.

FIG. 1 is a process flow diagram of embodiments 1˜4 provided by the present invention. Reference numerals: 1—molten glass mixed-flow stirring section; 1a—confluence channel; 1b—molten glass stirring tank; 1c—spoiler; 2—molten glass heating, clarifying and cooling section; 2a—heating channel; 2b—clarifying tank; 2c—cooling channel; 3—liquid supply tank; 4—serpentine flow channel; 5—melting furnace.

### DETAILED DESCRIPTION OF THE INVENTION

In order to make the objectives, technical solutions, and advantages of the present invention clearer and more comprehensible, the present invention will be descried further in detail below with reference to the accompanying drawings and embodiments. Obviously, the embodiments described are only a part of the embodiments of the present application and not all of them. All other embodiments obtained by those of ordinary skills in the art based on the embodiments of the present application would fall within the protection scope of the present application.

### Embodiment 1

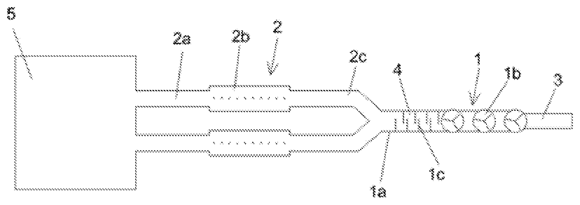

As shown in FIG. 1, a large-flow precious metal channel includes a molten glass mixed-flow stirring section 1 that includes a confluence channel 1a with a diameter of 400 mm and a length of 3000 mm. One end of the confluence channel 1a is communicated with two cooling channels 2c with diameters of 280 mm and lengths of 3000 mm. A set of spoilers 1c are welded in the confluence channel 1a, and include eight spoilers 1c that are distributed in a mutually staggered manner. A serpentine flow channel 4 is formed inside the confluence channel 1a by the division of the eight spoilers 1c.

Three molten glass stirring tanks 1b, with diameters of 400 mm, rotation speeds of 3 revolutions per minute and stirring directions of counterclockwise, clockwise, and counterclockwise directions respectively, are sequentially communicated with the confluence channel 1a at one end of the serpentine flow channel 4. A liquid supply tank 3 with a diameter of 360 mm and a length of 1600 mm is communicated with the liquid outlet of the last molten glass stirring tank 1b.

At the other end of the confluence channel 1a, two molten glass heating, clarifying and cooling sections 2 with the same size and structure are connected. The molten glass heating, clarifying and cooling section 2 includes a heating channel 2a with a diameter of 200 mm and a length of 1000 mm, which is communicated with the melting furnace 5 at one end and is communicated with a clarifying tank 2b with a diameter of 300 mm and a length of 5000 mm and a cooling tank 2c sequentially at the other end. The liquid outlet ends of cooling channels 2c of the two molten glass heating, clarifying and cooling sections 2 are all communicated with the confluence channel 1a.

The heating channel 2a, clarifying tank 2b, cooling channel 2c, confluence channel 1a, molten glass stirring tank 1b, spoilers 1c and liquid supply tank 3 are all made of precious metal platinum rhodium alloy. The heating channel 2a, the clarifying tank 2b, the cooling channel 2c, the confluence channel 1a and the liquid supply tank 3 are all connected with wires and thermocouples, which are connected and incorporated with a console not shown in the FIGURE. Based on the signal transmitted by the thermocouple and through the console, one can check the detected temperature and control the power of the current input, and then control the working temperature of the heating channel 2a to 1630° C., the working temperature of the clarifying tank 2b to 1650° C., the working temperature of the cooling channel 2c to 1520° C., the working temperature of the confluence channel 1a to 1470° C., and the working temperature of the liquid supply tank 3 to 1300° C.

Finally, the molten glass enters the float tin bath through the liquid supply tank 3 for precise formation, and the 8.5-generation float TFT-LCD glass substrate is produced. After the subsequent quality inspection, the produced 8.5-generation float TFT-LCD glass substrate has no bubbles and streaks. The daily melting capacity of the glass furnace in this embodiment is 35 tons per day.

### Embodiment 2

As shown in FIG. 1, a large-flow precious metal channel includes a molten glass mixed-flow stirring section 1 that includes a confluence channel 1a with a diameter of 300 mm and a length of 5000 mm. One end of the confluence channel 1a is communicated with two cooling channels 2c with diameters of 220 mm and lengths of 2000 mm. A set of spoilers 1c are welded in the confluence channel 1a, and include five spoilers 1c that are distributed in a mutually staggered manner. A serpentine flow channel 4 is formed inside the confluence channel 1a by the division of the five spoilers 1c.

Three molten glass stirring tanks 1b, with diameters of 350 mm, rotation speeds of 8 revolutions per minute and stirring directions of clockwise, counterclockwise, and clockwise directions respectively, are sequentially communicated with the confluence channel 1a at one end of the serpentine flow channel 4. A liquid supply tank 3 with a diameter of 300 mm and a length of 2000 mm is communicated with the liquid outlet of the last molten glass stirring tank 1b.

At the other end of the confluence channel 1a, two molten glass heating, clarifying and cooling sections 2 with the same size and structure are connected. The molten glass heating, clarifying and cooling section 2 includes a heating channel 2a with a diameter of 150 mm and a length of 500 mm, which is communicated with the melting furnace 5 at one end, and is communicated with a clarifying tank 2b with a diameter of 250 mm and a length of 3000 mm and a cooling tank 2c sequentially at the other end. The liquid outlet ends of the cooling channels 2c of the two molten glass heating, clarifying and cooling sections 2 are all communicated with the confluence channel 1a.

The heating channel 2a, clarifying tank 2b, cooling channel 2c, confluence channel 1a, molten glass stirring tank 1b, spoilers 1c and liquid supply tank 3 are all made of precious metal platinum. The heating channel 2a, the clarifying tank 2b, the cooling channel 2c, the confluence channel 1a and the liquid supply tank 3 are all connected with wires and thermocouples, which are connected and incorporated with a console not shown in the FIGURE. Based on the signal transmitted by the thermocouple and through the console, one can check the detected temperature and control the power of the current input, and then control the working temperature of the heating channel 2a to 1620° C., the working temperature of the clarifying tank 2b to 1640° C., the working temperature of the cooling channel 2c to 1500° C., the working temperature of the confluence channel 1a to 1450° C., and the working temperature of the liquid supply tank 3 to 1200° C.

Finally, the molten glass enters the overflow tank through the liquid supply tank 3 for precise formation, and the 8.5-generation TFT-LCD glass substrate is produced by overflow. After the subsequent quality inspection, the 8.5-generation TFT-LCD glass substrate produced by overflow has no bubbles and streaks. The daily melting capacity of the glass furnace in this embodiment is 20 tons per day.

### Embodiment 3

As shown in FIG. 1, a large-flow precious metal channel includes a molten glass mixed-flow stirring section 1 that includes a confluence channel 1a with a diameter of 500 mm and a length of 2000 mm. One end of the confluence channel 1a is communicated with two cooling channels 2c with diameters of 360 mm and lengths of 6000 mm. A set of spoilers 1c are welded in the confluence channel 1a, and include twelve spoilers 1c that are distributed in a mutually staggered manner. A serpentine flow channel 4 is formed inside the confluence channel 1a by the division of the twelve spoilers 1c.

Three molten glass stirring tanks 1b with diameters of 550 mm, rotation speeds of 18 revolutions per minute and stirring directions of counterclockwise, clockwise, and counterclockwise directions respectively, are sequentially communicated with the confluence channel 1a at one end of the serpentine flow channel 4. A liquid supply tank 3 with a diameter of 500 mm and a length of 1000 mm is communicated with the liquid outlet of the last molten glass stirring tank 1b.

At the other end of the confluence channel 1a, two molten glass heating, clarifying and cooling sections 2 with the same size and structure are connected. The molten glass heating, clarifying and cooling section 2 includes a heating channel 2a with a diameter of 300 mm and a length of 1500 mm, which is communicated with the melting furnace 5 at one end, and is communicated with a clarifying tank 2b with a diameter of 400 mm and a length of 8000 mm and a cooling tank 2c sequentially at the other end. The liquid outlet ends of the cooling channels 2c of the two molten glass heating, clarifying and cooling sections 2 are all communicated with the confluence channel 1a.

The heating channel 2a, clarifying tank 2b, cooling channel 2c, confluence channel 1a, molten glass stirring tank 1b, spoilers 1c and liquid supply tank 3 are all made of precious metal platinum iridium alloy. The heating channel 2a, the clarifying tank 2b, the cooling channel 2c, the confluence channel 1a and the liquid supply tank 3 are all connected with wires and thermocouples, which are connected and incorporated with a console not shown in the FIGURE. Based on the signal transmitted by the thermocouple and through the console, one can check the detected temperature and control the power of the current input, and then control the working temperature of the heating channel 2a to 1650° C., the working temperature of the clarifying tank 2b to 1670° C., the working temperature of the cooling channel 2c to 1550° C., the working temperature of the confluence channel 1a to 1500° C., and the working temperature of the liquid supply tank 3 to 1400° C.

Finally, the molten glass enters the float tin bath through the liquid supply tank 3 for precise formation, and the 11-generation float TFT-LCD glass substrate is produced. After the subsequent quality inspection, the produced 11-generation float TFT-LCD glass substrate has no bubbles and streaks. The daily melting capacity of the glass furnace in this embodiment is 100 tons per day.

### Embodiment 4

As shown in FIG. 1, a large-flow precious metal channel includes a molten glass mixed-flow stirring section 1 that includes a confluence channel 1a with a diameter of 450 mm and a length of 2600 mm. One end of the confluence channel 1a is communicated with two cooling channels 2c with diameters of 330 mm and lengths of 5500 mm. A set of spoilers 1c are welded in the confluence channel 1a, and include ten spoilers 1c that are distributed in a mutually staggered manner. A serpentine flow channel 4 is formed inside the confluence channel 1a by the division of the ten spoilers 1c.

Three molten glass stirring tanks 1b, with diameters of 500 mm, rotation speeds of 13 revolutions per minute and stirring directions of clockwise, counterclockwise, and clockwise directions respectively, are sequentially communicated with the confluence channel 1a at one end of the serpentine flow channel 4. A liquid supply tank 3 with a diameter of 450 mm and a length of 1200 mm is communicated with the liquid outlet of the last molten glass stirring tank 1b.

At the other end of the confluence channel 1a, two molten glass heating, clarifying and cooling sections 2 with the same size and structure are connected. The molten glass heating, clarifying and cooling section 2 includes a heating channel 2a with a diameter of 280 mm and a length of 1300 mm, which is communicated with the melting furnace 5 at one end, and is communicated with a clarifying tank 2b with a diameter of 380 mm and a length of 7000 mm and a cooling tank 2c sequentially at the other end. The liquid outlet ends of the cooling channels 2c of the two molten glass heating, clarifying and cooling sections 2 are all communicated with the confluence channel 1a.

The heating channel 2a, clarifying tank 2b, cooling channel 2c, confluence channel 1a, molten glass stirring tank 1b, spoilers 1c and liquid supply tank 3 are all made of precious metal platinum iridium alloy. The heating channel 2a, the clarifying tank 2b, the cooling channel 2c, the confluence channel 1a and the liquid supply tank 3 are all connected with wires and thermocouples, which are connected and incorporated with a console not shown in the FIGURE. Based on the signal transmitted by the thermocouple and through the console, one can check the detected temperature and control the power of the current input, and then control the working temperature of the heating channel 2a to 1650° C., the working temperature of the clarifying tank 2b to 1650° C., the working temperature of the cooling channel 2c to 1510° C., the working temperature of the confluence channel 1a to 1470° C., and the working temperature of the liquid supply tank 3 to 1350° C.

Finally, the molten glass enters the overflow tank through the liquid supply tank 3 for precise formation, and the 10.5-generation TFT-LCD glass substrate is produced by overflow. After the subsequent quality inspection, the 10.5-generation TFT-LCD glass substrate produced by overflow has no bubbles and streaks. The daily melting capacity of the glass furnace in this embodiment is 70 tons per day.

The above are only preferred embodiments of the present invention. It should be noted that for those skilled in the art, several improvements and changes can be made without departing from the inventive concept of the present invention, and all fall within the protection scope of the present invention.

What is claimed is:

1. A large-flow precious metal channel, comprising a molten glass mixed-flow stirring section (1), wherein, at least two molten glass heating, clarifying and cooling sections (2) are connected in parallel at one end of the molten glass mixed-flow stirring section (1), the other end of which is communicated with a liquid supply tank (3); each of the molten glass heating, clarifying and cooling sections (2) comprises a heating channel (2a), which is communicated with a melting furnace (5) at one end and is communicated with a clarifying tank (2b) and a cooling channel (2c) sequentially at the other end; the molten glass mixed-flow stirring section (1) comprises a confluence channel (1a), which is communicated with the cooling channel (2c) at one end; a set of spoilers (1c) are provided in the confluence channel (1a), a stirring channel is communicated with the other end of the confluence channel (1a) and comprises at least one molten glass stirring tank (1b), and a liquid outlet of the molten glass stirring tank (1b) is communicated with the liquid supply tank (3).

2. The large-flow precious metal channel of claim 1, wherein, spoilers (1c) in the set of spoilers (1c) are distributed in a staggered manner, and a serpentine flow channel (4) is formed inside the confluence channel (1a) by a division of the set of spoilers (1c).

3. The large-flow precious metal channel of claim 1, wherein, the confluence channel (1a) is communicated with at least one molten glass stirring tank (1b) sequentially at the other end, and stirring directions of two adjacent molten glass stirring tanks (1b) are different.

4. The large-flow precious metal channel of claim 1, wherein, the heating channel (2a) has a diameter of 150 mm to 300 mm and a length of 500 mm to 1500 mm; the clarifying tank (2b) has a diameter of 250 mm to 400 mm and a length of 3000 mm to 8000 mm; the cooling channel (2c) has a diameter of 220 mm to 360 mm and a length of 2000 mm to 6000 mm; the confluence channel (1a) has a diameter of 300 mm to 500 mm and a length of 2000 mm to 5000 mm; the molten glass stirring tank (1b) has a diameter of 350 mm to 550 mm and a stirring speed of 2 to 20 revolutions per minute; the liquid supply tank (3) has a diameter of 300 mm to 500 mm and a length of 1000 mm to 2000 mm.

5. The large-flow precious metal channel of claim 1, wherein, a maximum temperature of the heating channel (2a) during operation is 1650° C., and a maximum temperature of the clarifying tank (2b) during operation is 1670° C., a temperature of the cooling channel (2c) during operation is 1500° C. to 1550° C., and a temperature of the liquid supply tank (3) during operation is 1200° C. to 1400° C.

6. The large-flow precious metal channel of claim 1, wherein, the heating channel (2a), the clarifying tank (2b), the cooling channel (2c), the confluence channel (1a), the molten glass stirring tank (1b), the set of spoilers (1c) and the liquid supply tank (3) are made of platinum rhodium alloy or platinum iridium alloy or platinum.
